(19) United States
(12) Patent Application Publication
(10) Pub. No.: US 2012/0274747 A1
(43) Pub. Date: Nov. 1, 2012

(54) STEREOSCOPIC VIDEO DISPLAY DEVICE AND STEREOSCOPIC VIDEO DISPLAY METHOD

(76) Inventor: Goki Yasuda, Ome-shi (JP)

(21) Appl. No.: 13/302,768

(22) Filed: Nov. 22, 2011

(30) Foreign Application Priority Data
Apr. 27, 2011 (JP) 2011-099746

(51) Int. Cl. H04N 13/04

(52) U.S. Cl. 348/51; 348/E13.026

(57) ABSTRACT

According to one embodiment, there is provided a stereoscopic video display device including a depth information generator, a depth controller, an image generator, and an image display unit. The depth controller creates a weighted histogram of the depth value by weighting a frequency of each depth value, and adjusts the depth value by using an accumulated weighted histogram obtained from the histogram.

### CROSS-REFERENCE TO RELATED APPLICATIONS

This application is based upon and claims the benefit of priority from prior Japanese Patent Application No. 2011-099746, filed Apr. 27, 2011, the entire contents of which are incorporated herein by reference.

### FIELD

Embodiments described herein relate generally to image processing and particularly to a stereoscopic image processing device and a stereoscopic image processing method capable of providing a stereoscopic image.

### BACKGROUND

In recent years, image display technology has progressed to bring about proposals for stereoscopic image processing systems capable of displaying stereoscopic images to users. One of the stereoscopic image processing systems through which users can perceive stereoscopic images is based on a scheme using shutter glasses. According to this scheme, a left eye image and a right eye image between which parallax exists are displayed alternately on a display device. By controlling liquid crystal shutters in the shutter glasses to open/close, a user is allowed to see the left eye image only from the left eye as well as the right eye image from the right eye. As a result, the user perceives the images displayed on the display device as a stereoscopic image.

In such a stereoscopic video display device, a sense of depth of a video is produced in a manner that display positions of an object in the left and right eye images are shifted in leftward and rightward directions. Depending on displacement (referred to as depth information in this case) of the positions shifted in the leftward and rightward directions, the object looks near or far. The depth information is added to each of displayed pixels.

Depending on imaging conditions such as a positional relationship between a target object and a camera or a display condition such as a size of a depth range capable of displaying a stereoscopic image, there is a case that the stereoscopic image cannot express thickness of the imaged target object and a natural sense of depth cannot be obtained. Even in this case, a method is available which smoothes (flattens) depth information for each pixel throughout a whole of a depth range which a display device can reproduce. In this method, a histogram indicative of frequencies of depth information (depth values) is prepared first, and further, an accumulated histogram which accumulates the frequencies is further prepared. The depth information is smoothed by converting the depth information with use of the accumulated histogram.

If the depth information is adjusted by smoothing the histogram with use of the accumulated histogram of depth values, the area of the histogram is deviated to a deep side in the depth range, for example, in a video which includes a large background area. Consequently, a gradient of the histogram increases, and excessive depth information is assigned to the deep side. Therefore, the depth range is compacted in the front side and causes a problem that a natural sense of depth cannot be obtained.

The embodiments described herein have an object of providing a stereoscopic video display device capable of reproducing a natural sense of depth by emphasizing a sense of depth in the front side without assigning an depth range excessively unbalanced to background areas.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing a configuration of the first embodiment of a stereoscopic video display device;

FIG. 2 shows an example of generating depth values with reference to a front end position of a whole depth range;

FIG. 3 is a flowchart showing an exemplary processing operation of a depth controller 12;

FIG. 4 is a histogram showing frequencies of depth values d in one frame;

FIG. 5 shows a weighting function according to an embodiment;

FIG. 6 shows a weighted histogram of depth values according to the embodiment;

FIG. 7 shows a weighting calculated for each depth value by using a first weighting function according to the embodiment;

FIG. 8 shows a weighting calculated for each depth value by using a second weighting function according to the embodiment;

FIG. 9 shows a weighting calculated for each depth value by using a third weighting function according to the embodiment;

FIG. 10 shows a weighting calculated for each depth value by using a fourth weighting function according to the embodiment;

FIG. 11 shows an accumulated weighted histogram according to the embodiment;

FIG. 12 shows a depth adjustment function DF(d) according to the embodiment;

FIG. 13 shows a conventional accumulated histogram;

FIG. 14 shows a depth adjustment function obtained on the basis of the accumulated histogram shown in FIG. 13;

FIG. 15 is a block diagram showing a configuration of the second embodiment of a stereoscopic video display device;

FIG. 16 is a block diagram showing a configuration of the third embodiment of a stereoscopic video display device;

FIGS. 17A, 17B and 17C show a vector Vmax, a vector Vmin, and a parallax amount p according to the third embodiment;

FIG. 18 is a block diagram showing a configuration of the fourth embodiment of a stereoscopic video display device; and

FIG. 19 shows a depth adjustment function where α=0.5 is given in depth adjustment according to the fifth embodiment.

### DETAILED DESCRIPTION

Various embodiments will be described hereinafter with reference to the accompanying drawings.

In general, according to one embodiment, there is provided a stereoscopic video display device comprising: a depth information generator 11 configured to generate a depth value from an input image; a depth controller 12 configured to adjust the depth value and generate an adjusted depth value; an image generator 13 configured to generate a right viewpoint image and a left viewpoint image from the input image and the adjusted depth value; and an image display unit 14 configured to display a stereoscopic image, based on the right and left viewpoint images. The depth controller 12 obtains a weighted histogram of the depth value by weighting a frequency of each depth value. Thereafter, each depth value is adjusted by smoothing the weighted histogram with use of a depth adjustment function which is obtained from the accumulated histogram.

Specifically, in the embodiment, a weighted histogram of depth values is obtained by weighting frequencies of depth values corresponding to depth information. Thereafter, the depth values are adjusted by smoothing the weighted histogram with use of a depth adjustment function obtained from an accumulated histogram.

Hereinafter, a stereoscopic video display device according to embodiments will be described with reference to the drawings.

### First Embodiment

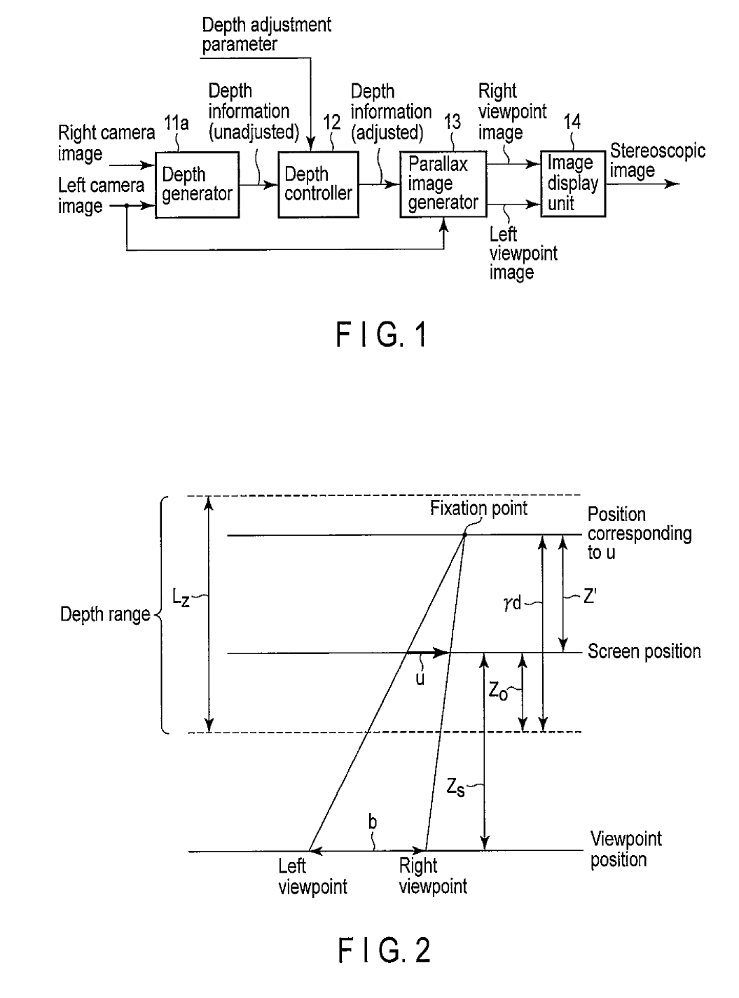

FIG. 1 is a block diagram showing a configuration of the first embodiment of a stereoscopic video display device.

The stereoscopic video display device is an example of displaying a stereoscopic image by inputting a right camera image and a left camera image. The stereoscopic video display device according to the first embodiment comprises a depth generator 11a, a depth controller 12, and an image display unit 14. The right camera image is input to the depth generator lie, and the left camera image is input to both the depth generator 11a and a parallax image generator 13.

The depth generator 11a generates and outputs depth information from the right and left camera images. The depth information and a depth adjustment parameter are input to the depth controller 12. The depth controller 12 adjusts the depth information, based on the depth adjustment parameter, and outputs adjusted depth information. The adjusted depth information is input to the parallax image generator 13. The parallax image generator 13 generates and outputs a right viewpoint (right eye) image and a left viewpoint (right eye) image, based on the left camera image and the depth information. The right and left viewpoint images are input to the image display unit 14. The image display unit 14 displays a stereoscopic image, based on the right and left viewpoint images.

Hereinafter, sections forming the stereoscopic video display device will be described in details.

The depth generator 11a performs stereoscopic matching by using the right and left camera images. Specifically, the depth generator 11a calculates a vector (hereinafter referred to as a matching vector) which extends from a matching point in the left camera image, as a start point, to a matching point in the right camera image, as an end point. The matching vector has a size and a direction (leftward or rightward). The depth generator 11a generates depth information as a depth value by using the calculated matching vector.

To generate a depth value from the matching vector, for example, a method described in paragraphs 0016 to 0018 in Jpn. Pat. Appln. KOKAI Publication No. 2001-298753 may be used. FIG. 2 shows an example in which the depth value is generated in relation to, as a reference, a front end position of a depth range which the display device can express.

The depth value is expressed as d. A horizontal component of the matching vector is expressed as u (cm). An interocular distance is expressed as b (cm). The whole depth range is expressed as L_{Z} (cm). A distance from a display screen position to the front end position of the depth range L_{Z} is expressed as Z₀ (cm). A distance from viewpoints (eyes) to the screen position is expressed as Z_{S} (cm). A constant to convert the depth value into a distance is expressed as γ. In FIG. 2, a fixation point is a pixel which is seen at a corresponding depth.

Where the rightward direction is a positive direction for the matching vector and a size of the matching vector is obtained in units of pixels, a value obtained by converting the matching vector in units of cm, based on a lateral width of the screen and a number of pixels in a horizontal direction, is used as u (cm). Where the horizontal component of the matching vector is uₚᵢₓₑₗ (pixels), the lateral width of the screen is W (cm), and the number of pixels in the horizontal direction is hₚᵢₓₑₗ (pixels), the horizontal component u (cm) of the matching vector is obtained as follows.

$$u = \frac{W}{{h}_{pixel}} {u}_{pixel} \qquad ( 1 )$$

The constant γ to convert a depth value into a distance is set as follows, for example, where the depth value d is expressed in 256 gradations of 0 to 255.

$$v = \frac{{L}_{z}}{255} \qquad ( 2 )$$

A distance z′ from the screen position to the fixation point is expressed as follows.

z′=γd−z_{O} (3)

A next equation is obtained from a scaling relationship between triangles in FIG. 2.

z′:(z′+z_{S})=u:b (4)

The depth value d is obtained by an equation below from the equations (3) and (4).

$$d = \frac{( b - u ) {z}_{0} + {uz}_{s}}{v ( b - u )} \qquad ( 5 )$$

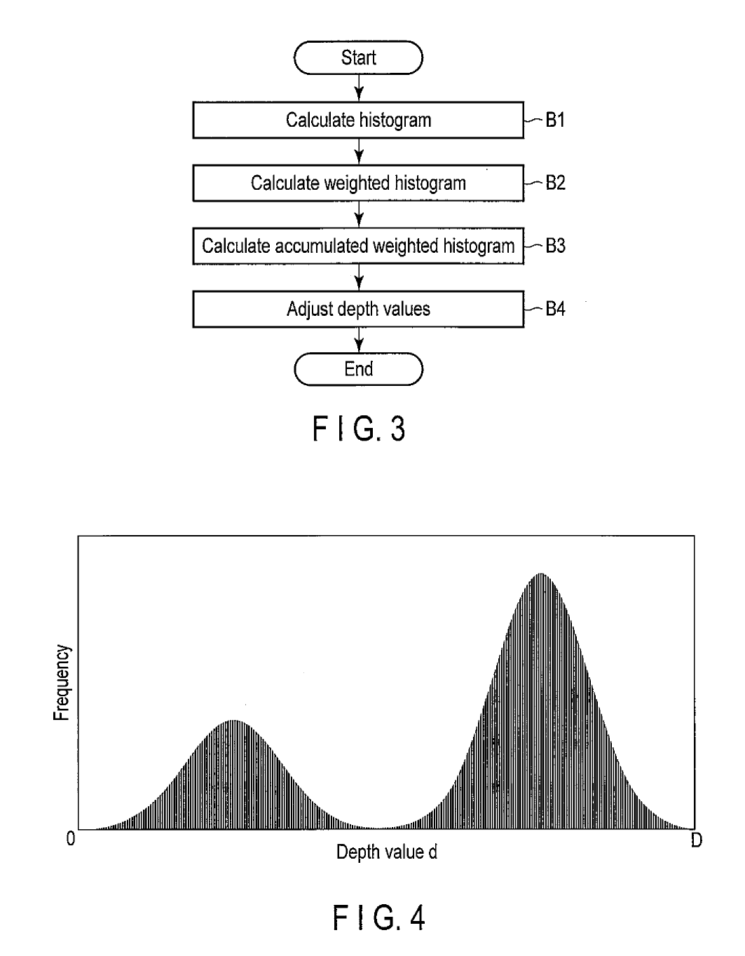

FIG. 3 is a flowchart showing a processing operation of the depth controller 12.

The depth controller 12 calculates a histogram as shown in FIG. 4, which shows a frequency at each depth value d input from the depth generator 11a in a frame (block B1). The depth controller 12 weights frequencies of the depth values d, depending on the depth values. A minimum value of the depth values is supposed to be 0, and a maximum value thereof is supposed to be D. The maximum value D is 255, for example, where resolution of the depth value is the eighth power of 2. The maximum value D is a value dependent on design specs of the display system.

The histogram is calculated by obtaining frequencies by counting the number of pixels for each depth value, in units of frames. The histogram is expressed by an expression below, as a set of frequencies of depth values.

{P(d)|d=0, . . . ,D} (6)

Now, the maximum value of the depth value is supposed to be D, and a frequency of each depth value is supposed to be P(d).

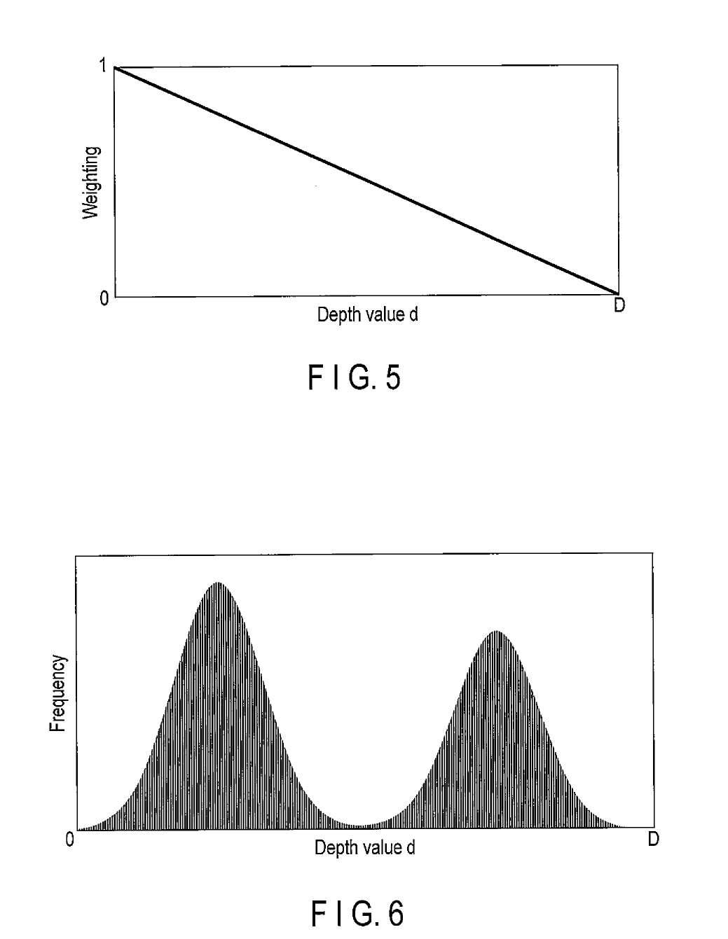

The depth controller 12 multiplies each frequency in the histogram as shown in FIG. 4 by a weighting expressed by a weighting function as shown in FIG. 5, to thereby calculate a weighted histogram of depth values as shown in FIG. 6 (block B2).

FIG. 5 shows an example of weightings which are set depending on the depth values d. In this example, depth resolution is set to 256, and weightings which linearly decreases from 1 to 0 are set for the whole depth range L_{Z} which ranges from a depth value of the nearest pixel (d=0) to a depth value of the deepest pixel (d=255).

The weighted histogram is calculated as follows.

P_{w}(d)=w(d)P(d) (d=0, . . . ,D) (7)

Now, the weighting function is expressed as w(d), and weighted frequencies of depth values are expressed as Pw(d). A calculation method for the weighting function w(d) is not limited to the example of FIG. 5 but various methods are available as shown below by expressions (8) to (11)

$$\begin{matrix}w ( d ) = - \frac{1 - {θ}_{linear}}{D} d + 1 & ( 8 ) \\ w ( d ) = \frac{1 - {φ}_{convex}}{{D}^{2}} {( d - D )}^{2} + {φ}_{convex} & ( 9 ) \\ w ( d ) = - \frac{1 - {θ}_{convex}}{{D}^{2}} {d}^{2} + 1 & ( 10 ) \\ w ( d ) = \{ \begin{matrix}- \frac{1}{{φ}^{2}} {( x - φ )}^{2} + 1 & 0 \leq d < φ \\ - \frac{1}{{( D - φ )}^{2}} {( x - φ )}^{2} + 1 & φ \leq d \leq D\end{matrix} & ( 11 )\end{matrix}$$

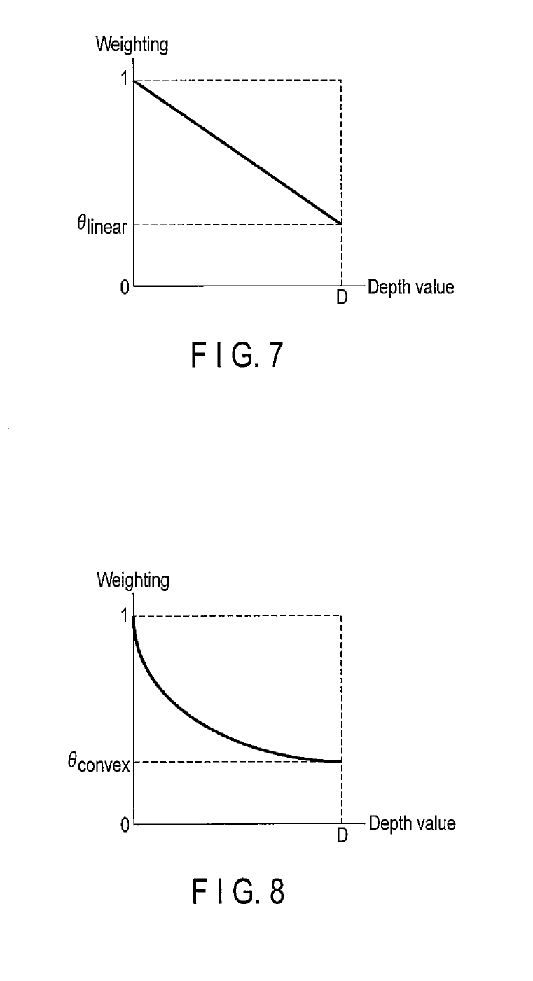

FIG. 7 shows weightings calculated for respective depth values by using the foregoing expression (8). In this example, a weighting 1 is set for a depth value of a pixel at the front end, and θlinear is set for a depth value of the deepest pixel (d=D), within the whole depth range L_{Z}. Weightings which linearly decrease from 1 to θlinear are set respectively for depth values 0 to D. The θlinear is a parameter of the weighting function and satisfies θlinearε[0, 1]. That is, θlinear is a value included between 0 and 1. The parameter of the weighting function is given as a depth information parameter to the depth information controller 12.

FIG. 8 shows a weighting which is calculated for each depth value by using the expression (9) above. In this example, a weighting 1 is set for a depth value of a pixel at the front end, and θconvex is set for a depth value of the deepest pixel (d=D), in the whole depth range L_{Z}. Weightings which decrease from 1 to θconvex, plotting a downwardly convex curve, are set for depth values 0 to D. The θconvex is a parameter of the weighting function and satisfies θconvexε[0, 1].

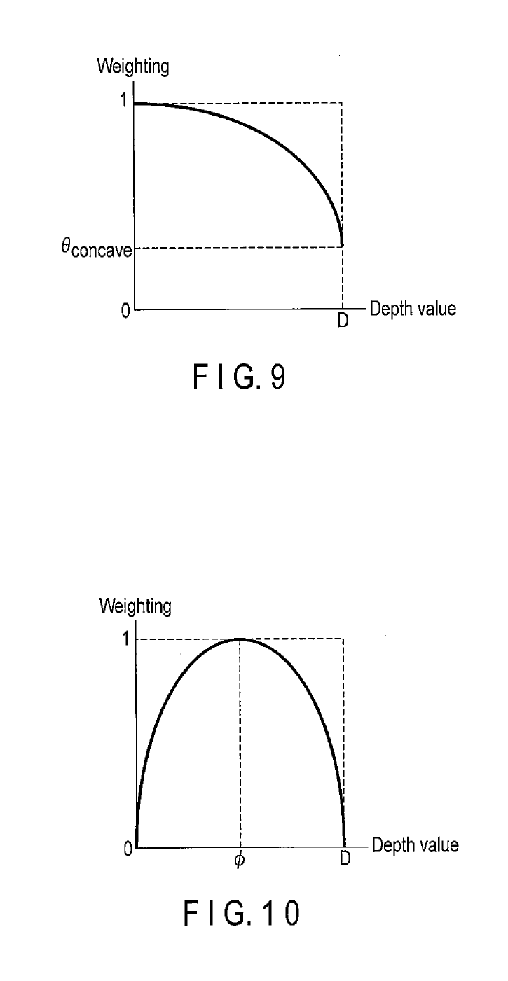

FIG. 9 shows a weighting which is calculated for each depth value by using the expression (10) above. In this example, a weighting 1 is set for a depth value of a pixel at the front end, and θconcave is set for a depth value of the deepest pixel (d=D), in the whole depth range L_{Z}. Weightings which decrease from 1 to θconcave, plotting an upwardly convex curve, are set for depth values 0 to D. The θconcave is a parameter of the weighting function and satisfies θconcaveε[0, 1].

FIG. 10 shows a weighting which is calculated for each depth value by using the expression (11) above. In this example, a weighting 0 is set for a depth value of a pixel at the front end, and a weighting 0 is also set for a depth value of the deepest pixel (d=D), in the whole depth range L_{Z}. A weighting 1 is set for intermediate depth values φ (for example, near the display screen). Weightings which change along an upwardly convex curve having an apex at the weighting 1 are set for depth values 0 to D. The φ is a parameter of the weighting function and satisfies φε[0, D].

When the weightings are increased in the front side and are decreased in the deep side, as suggested by the expressions (8) to (10) and in FIGS. 7 to 9, a sense of depth in the front side can be emphasized by assigning a depth range to be broad in the front side. Alternatively, when intermediate weightings are increased as suggested by the expression (11) and shown in FIG. 10, a sense of depth in the intermediate area can be emphasized by assigning a depth range to be broad in an intermediate area.

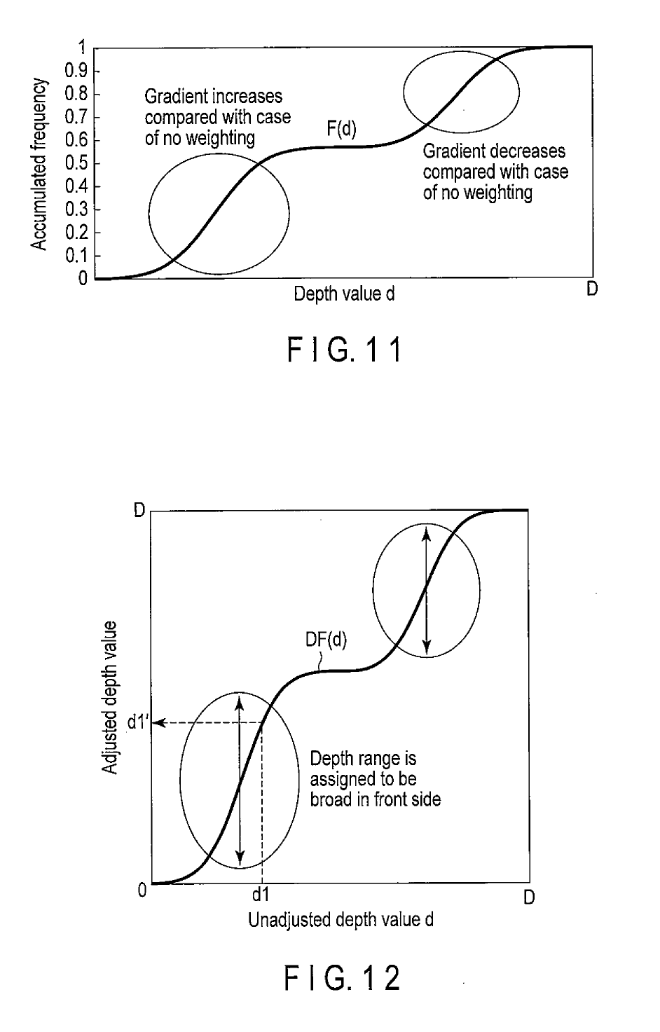

Further, the depth controller 12 calculates an accumulated weighted histogram as shown in FIG. 11, by accumulating frequencies in weighted histograms (block B3).

The accumulated weighted histogram is calculated by an expression below.

$$F ( d ) = \frac{1}{C} {\sum }_{i = 0}^{d} {P}_{w} ( i ) \qquad ( 12 )$$

In the expression, F(d) expresses the accumulated weighted histogram, and C is a normalization constant for satisfying F(d)ε[0, 1] and is expressed by an expression below.

$$C = {\sum }_{i = 0}^{D} {P}_{w} ( i ) \qquad ( 13 )$$

The depth controller 12 scales (up or down) the accumulated weighted histogram, to obtain a function DF(d) as shown in FIG. 12. The function DF(d) is to adjust depth values. This type of function used to adjust depth values will be hereinafter referred to as a depth adjustment function.

The horizontal axis in FIG. 12 represents the same depth values as in FIG. 11, and the vertical axis in FIG. 12 represents adjusted depth values which are obtained by multiplying accumulated frequencies on the vertical axis in FIG. 11 by the maximum value D (255) of the depth values. That is, the depth adjustment function DF(d) in FIG. 12 is obtained by scaling the weighted histogram of FIG. 11 in the vertical axis direction.

The depth controller 12 adjusts (converts) depth values by using the depth adjustment function DF(d) (block B4). The depth controller 12 converts the depth values d into an adjusted depth values d′ as follows by using the depth adjustment function DF(d).

d′=DF(d) (14)

In this expression, D is the maximum value (for example, 255).

Specifically, for example, when an unadjusted depth value d1 is given, a point representing d1 (coordinates (d1, 0)) is set on the horizontal axis of the graph. Next, an intersection (coordinates (d, DF(d)) between a vertical line penetrating the point d1 and the depth adjustment function is obtained. The depth controller 12 obtains an intersection (0, DF(d)) between a horizontal line penetrating the intersection and the vertical axis, and further obtains an adjusted depth value DF(d) from a value thereof on the vertical axis.

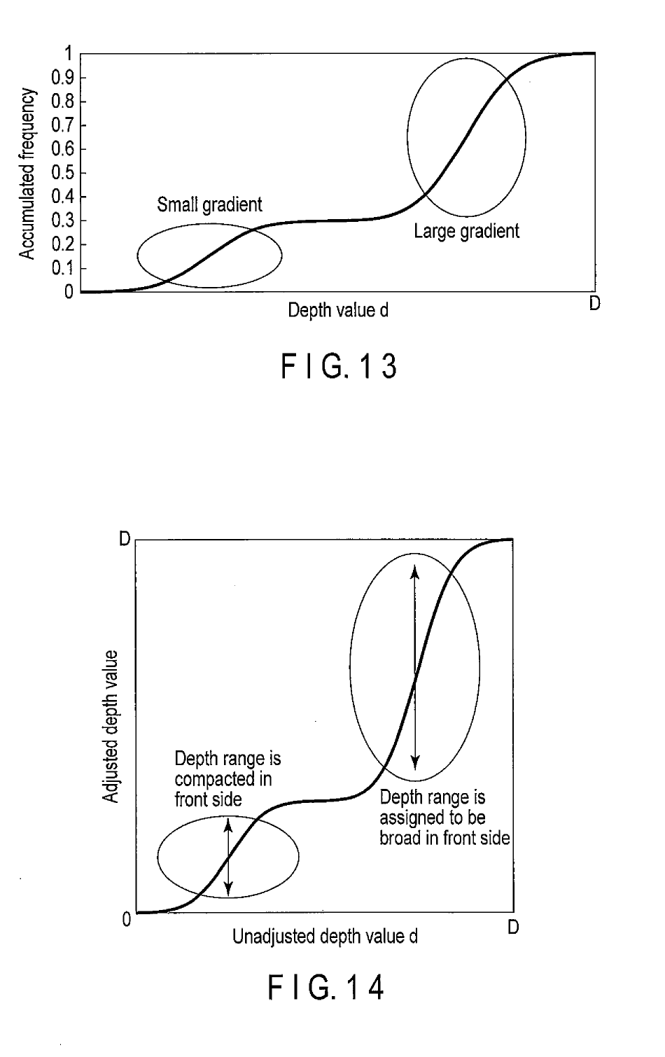

FIG. 13 shows a conventional accumulated histogram which is prepared on an unweighted histogram as shown in FIG. 4. About an image, a high percentage of which is occupied by a background image, the accumulated histogram has a large gradient in an area where depth values are large as shown in FIG. 13. Further, the accumulated histogram has a small gradient in an area displayed in the front side where depth values are small.

FIG. 14 shows a depth adjustment function which is obtained by scaling the accumulated histogram in FIG. 13. Even after the image, a high percentage of which is occupied by a background image, is subjected to adjustment to depth values in order to smooth the histogram, depth values are assigned broadly to the deep side of the depth range. The depth range is compacted (narrow) in the front side. Consequently, even when an image is displayed by use of the adjusted depth values, a natural sense of depth cannot be obtained.

In contrast, in the accumulated weighted histogram shown in FIG. 11 according to the present embodiment, the gradient of the accumulated histogram is small in an area displayed in the deep side where depth values are large, in comparison with an unweighted case (FIG. 13). In an area displayed in the front side where depth values are small, the gradient of the accumulated histogram is large compared with the unweighted case (FIG. 13).

Accordingly, as shown in FIG. 12, the depth range is assigned to be broad in the front side by the depth adjustment function DF(d) according to the present embodiment, compared with an unweighted case (FIG. 14). As a result, a sense of depth of pixels displayed in the front side is emphasized, and an image is provided with natural depths as a whole.

Referring back to FIG. 1, adjusted depth values for respective pixels are output from the depth controller 12 to the parallax image generator 13. The parallax image generator 13 outputs a left camera image directly as a left viewpoint (eye) image and generates a right viewpoint (eye) image by horizontally shifting pixels of a left camera image in accordance with depth information.

A type of display which displays a stereoscopic image by showing the right and left eye images in synchronization with operation of shutters provided in glasses wore by a user is used as the image display unit 14.

Advantages

According to the present embodiment, a sense of depth can be emphasized without assigning the depth range excessively unbalanced to the deep side including a background area. For example, when weightings are applied so as to increase in the front side and to decrease in the deep side as shown in FIGS. 7 to 9, an area of the weighted histogram is biased to be broad in the front side, compared with an ordinary histogram as shown in FIG. 6. As shown in FIG. 11, a gradient of the accumulated histogram in the front side of the depth range increases, compared with when weighting is not performed. As a result, after depth values are adjusted by use of the accumulated weighted histogram, the depth range is assigned to be broad in the front side, so that a sense of depth is emphasized in the front side. Accordingly, a natural sense of depth can be obtained.

### Second Embodiment

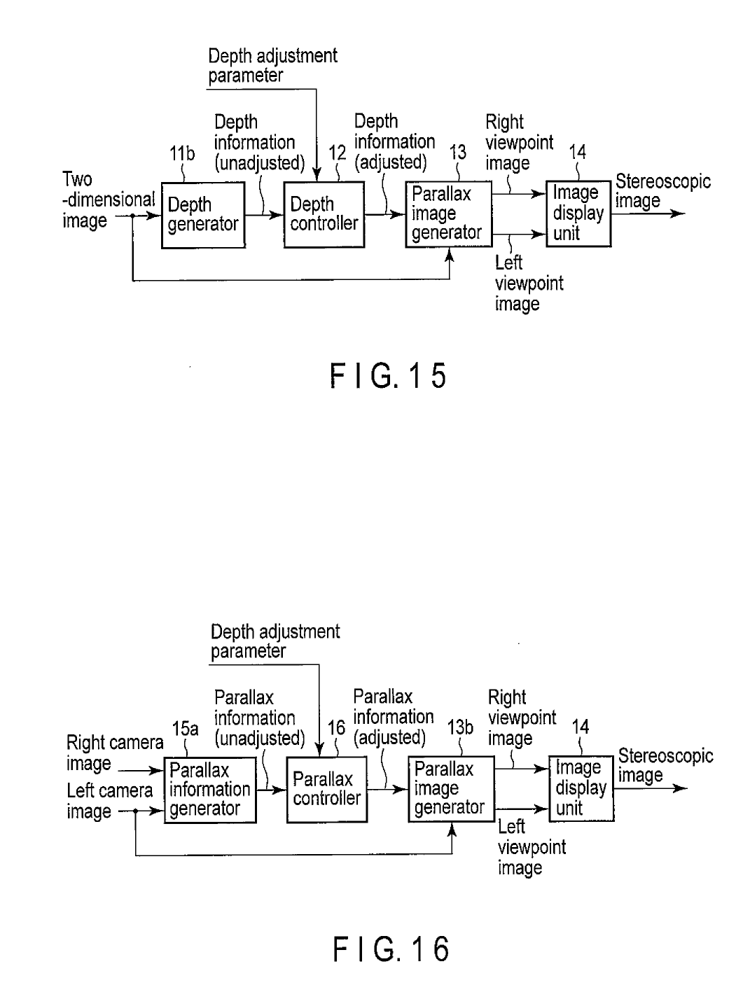

FIG. 15 is a block diagram showing a configuration of the second embodiment of a stereoscopic video display device.

The second embodiment is an example of a device which is input with a two-dimensional image imaged by a camera and displays a stereoscopic image. This stereoscopic video display device has the same basic configuration as the first embodiment. However, a difference exists in that a depth generator 11b and a parallax image generator 13 are input with a two-dimensional image.

The depth generator 11b firstly separates a two-dimensional video signal into a signal expressing an image of a background area and a signal expressing an image of the other areas, as disclosed in Jpn. Pat. Appln. KOKAI Publication No. 2000-261828. Further, a representative motion vector of the image of the background area is calculated from a motion vector of the two-dimensional video and a motion vector of the image of the background area. The depth generator 11b calculates a relative motion vector by subtracting the representative motion vector from the motion vector of the two-dimensional video. Further, depth information for the video of the two-dimensional video signal is generated by using the relative motion vector.

The parallax image generator 13 uses the two-dimensional image directly as a left viewpoint image, and generates the right viewpoint image by horizontally shifting pixels of the two-dimensional image in accordance with depth information, as also disclosed in Jpn. Pat. Appln. KOKAI Publication No. 2000-261828.

Advantages

Even when a three-dimensional image is generated from a two-dimensional image, a sense of depth is emphasized in the front side, and a natural sense of depth can be obtained, without assigning a depth range excessively unbalanced to a background area.

### Third Embodiment

FIG. 16 is a block diagram showing a configuration of the third embodiment of a stereoscopic video display device.

The third embodiment shows an example of a device which is input with right and left camera images and displays a stereoscopic image. This stereoscopic video display device has the same basic configuration as the first embodiment. However, a difference exists in that a parallax information generator 15a is comprised in place of a depth generator 11a, and parallax information is used as information for generating a parallax image without calculating a depth.

The parallax information generator 15a performs stereo matching by using right and left camera images. Specifically, the parallax information generator 15a calculates a matching vector (parallax amount) which extends from a position of a matching point in the left camera image as a start point to a position of a matching point in the right camera image as an end point. The parallax information generator 15a outputs the matching vector as parallax information.

A parallax controller 16 obtains a weighted histogram of parallax amounts by weighting frequencies of the parallax amounts, depending on the parallax amounts, and smoothes the histogram by an accumulated histogram obtained therefrom, thereby to adjust the strength of a sense of depth for each parallax amount.

The parallax amount p(x, y) is expressed as an expression below for each pixel.

p(x,y)=u(x,y)−Vₘᵢₙ (15)

In the expression above, u(x, y) is a horizontal component of a matching vector for a pixel at coordinates (x, y) on a screen, and Vmin is a minimum value of the horizontal component of the matching vector in a frame. The value of the parallax amount is hereinafter expressed as p.

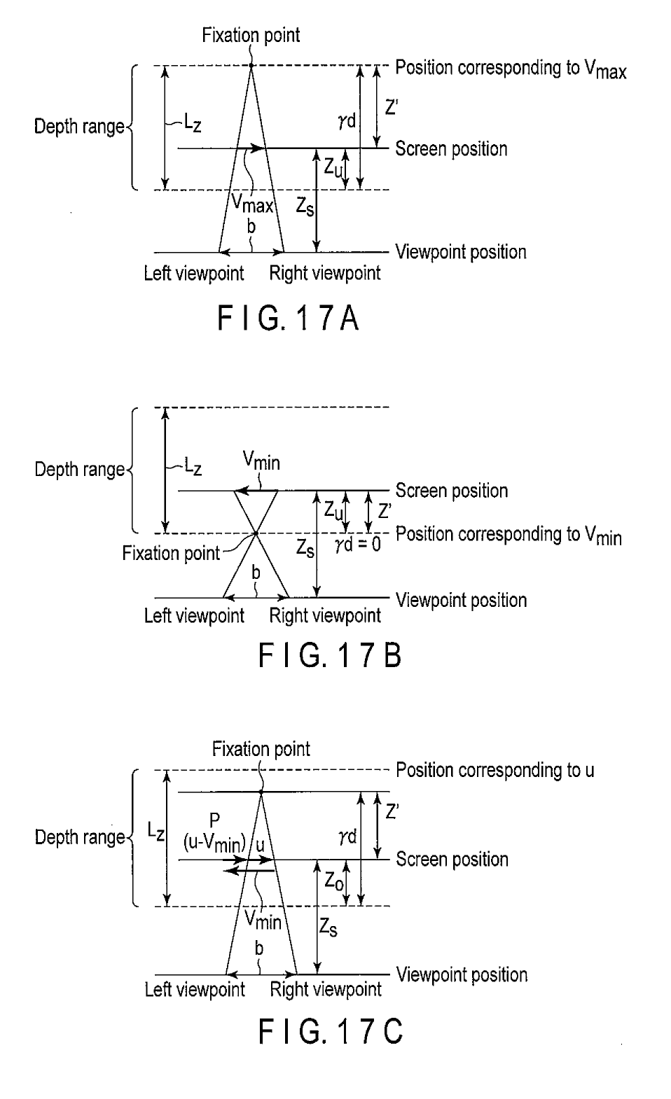

A maximum value of the horizontal components of the matching vectors in a frame is expressed as Vmax. FIG. 17A illustrates a vector Vmax. The vector Vmax is a matching vector for a pixel (fixation point) which is seen at the largest depth in a whole depth range L_{Z}. FIG. 17B illustrates a vector Vmin. The vector Vmin is a matching vector for a pixel (fixation point) which is seen at the front end in the whole depth range L_{Z}. FIG. 17C shows the parallax amount p. The parallax amount p has a size equal to a difference between a size of a matching vector u of a pixel which is seen at an arbitrary depth in the whole depth range L_{Z} and a size of the vector Vmin. The parallax amount p has the same direction as the matching vector u.

In general, the matching vector u or a horizontal component thereof according to the present embodiment may be called a parallax amount. However, the third embodiment employs the parallax amount p which is relative to, as a reference, the in-frame minimum value Vmin of the horizontal component of the matching vector. The greater the parallax amount p, the greater the depth. The smaller the parallax amount p, the smaller the depth. Therefore, a matching relationship with the depth is easy to understand.

A histogram is prepared by counting a number of pixels for each parallax amount in units of frames. The histogram is expressed as a set of frequencies of parallax amounts by an expression below.

{\tilde{P}(p)|p=0, . . . ,Vmax−Vmin} (16)

In this expression, frequencies for a parallax amount is expressed as \tilde{P}(p).

A weighted histogram is obtained by an expression below.

\tilde{P}_{w}(p)=\tilde{w}(p)\tilde{P}(p) (p=0, . . . ,Vmax−Vmin) (17)

The weighting function is expressed as \tilde{w}(p), and weighted frequencies for parallax amounts are expressed as \tilde{P}_{W}(p). The weighting function \tilde{w}(p) is calculated as w(d), for example, as in the first embodiment. However, a definite range of the weighting function is pε[0, Vₘₐₓ−Vₘᵢₙ]

The accumulated histogram is obtained by an expression below.

$$\tilde{F} ( p ) = \frac{1}{\tilde{C}} {\sum }_{i = 0}^{P} {\tilde{P}}_{W} ( i ) \qquad ( 18 )$$

In this example, \tilde{C} is a normalization coefficient to satisfy \tilde{F}(p)ε[0, 1], and is expressed by an expression below.

$$\tilde{C} = {\sum }_{i = 0}^{{V}_{m ax} - {V}_{m i n}} {\tilde{P}}_{W} ( i ) \qquad ( 19 )$$

An adjusted parallax amount p′ is obtained as follows by using the accumulated histogram.

p′=(V′ₘₐₓ−V′ₘᵢₙ)\tilde{F}(p) (20)

Now, V′min and V′max are minimum and maximum values of a horizontal component of an adjusted matching vector, and are predetermined. For example, V′min=Vmin and V′max=Vmax may be given.

A matching vector obtained from the adjusted parallax amount, as expressed by an expression below, is output as adjusted parallax information.

u′(x,y)=p′(x,y)+V′ₘᵢₙ (21)

In this expression, p′(x, y) is taken as an adjusted parallax amount for a pixel at coordinates (x, y).

Advantages

In addition to the advantages of the first embodiment, the third embodiment requires a far smaller calculation processing amount to calculate parallax amounts p than that the first embodiment requires to obtain depth values d. Therefore, a higher speed processing than the first embodiment can be achieved.

### Fourth Embodiment

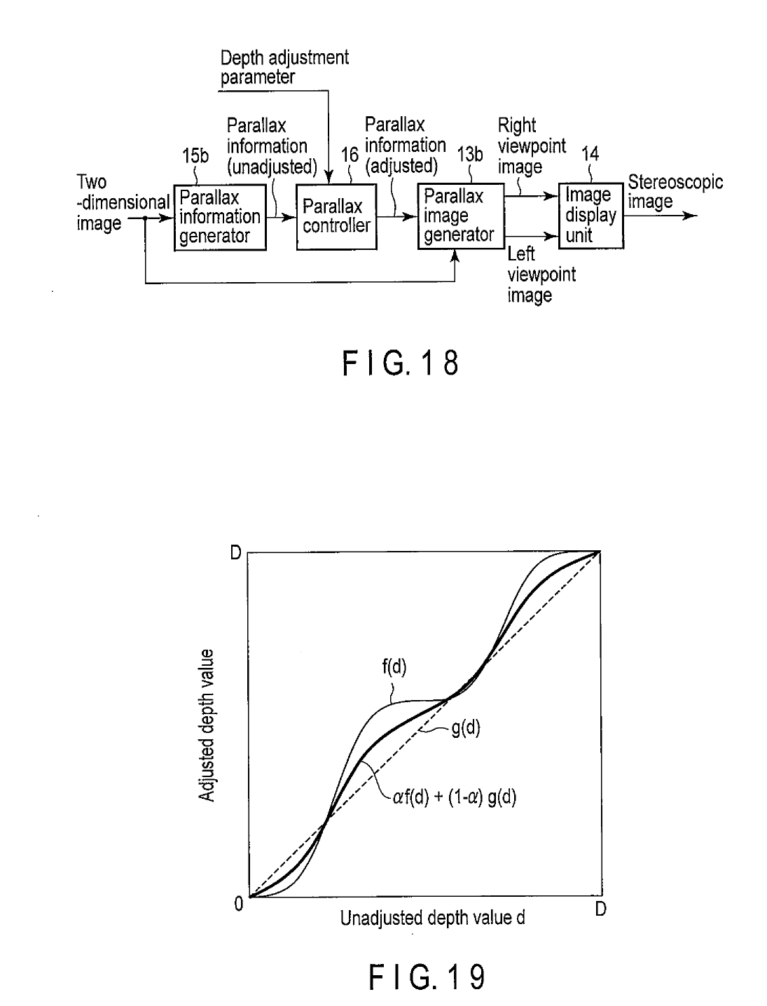

FIG. 18 is a block diagram showing a configuration of the fourth embodiment of a stereoscopic video display device.

The fourth embodiment relates to an example of a device which is input with a two-dimensional image and outputs a stereoscopic image. This stereoscopic video display device has the same basic configuration as the second embodiment shown in FIG. 15. However, a difference exists in that a parallax information generator 15b is comprised in place of a depth generator 11b, and parallax information is used as information to generate a parallax image without calculating a depth.

The parallax information generator 15b separates firstly a two-dimensional video signal into a signal expressing an image of a background area and a signal expressing an image of the other areas, as disclosed in Jpn. Pat. Appln. KOKAI Publication No. 2000-261828. Further, a representative motion vector of the image of the background area is calculated from a motion vector of the two-dimensional video and a motion vector of the image of the background area. The parallax information generator 15b calculates a relative motion vector by subtracting the representative vector from the motion vector of the two-dimensional video signal. The parallax information generator 15b further generates parallax information for the video of the two-dimensional video signal by using the relative motion vector.

Advantages

Even when a three-dimensional image is generated from a two-dimensional image, a sense of depth in the front side is emphasized. Therefore, a natural sense of depth can be obtained, and a higher-speed processing can be achieved than the second embodiment.

### Fifth Embodiment

Next, the fifth embodiment of a stereoscopic video display device will be described.

The fifth embodiment employs a function which combines a depth adjustment function calculated from an accumulated weighted histogram (expression d′=DF(d) according to the first embodiment) with another function, in adjustment to depth values. The stereoscopic video display device according to the fifth embodiment has the same basic configuration as the first embodiment, and therefore, a block diagram of the configuration will be omitted.

A processing flow performed by a depth controller 12 in the fifth embodiment is the same as that in the first embodiment. However, the fifth embodiment uses different functions to adjust depth values, from a function of the first embodiment.

In adjusting depth values, the following two depth adjustment functions are prepared.

ƒ(d)=DF(d) (22)

g(d)=d (23)

Adjusted depth values d′ are obtained as follows by a function which mixes the above two functions.

d′=αf(d)+(1−α)g(d) (24)

In the above expression, α is a parameter concerning a mixing ratio (αε[0, 1]). The parameter α concerning the mixing ratio is supplied as a depth information parameter to the depth information controller 12. The function g(d) is a linear function which directly expresses an unadjusted depth value itself. Accordingly, a sense of depth is strengthened as α increases. The sense of depth is weakened as a decreases. Therefore, strength of the sense of depth can be instinctively adjusted.

FIG. 19 shows an example when α=0.5 is given in depth adjustment according to the fifth embodiment. A thin-line curve expresses the function f(d) calculated from an accumulated histogram, and a dashed-line curve expresses the linear function g(d). A fat-line curve expresses a mixed function of both.

In the same manner as described in the fifth embodiment, a modified embodiment may be configured by employing a function which mixes a depth adjustment function calculated from an accumulated histogram in adjustment to depth values according to any of the second to fourth embodiments, with another function. A embodiment may be further modified so as to adjust depth values by using a function which mixes respectively different three or more depth adjustment functions based on weighting as shown in FIGS. 7 to 10.

Advantages

Strength of a sense of depth can be instinctively adjusted by preparing a depth adjustment function with use of two functions and by adjusting a mixing ratio α.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be without departing from the spirit of the inventions. The accompanying claims and their equivalents are intended to cover such forms or modifications as would fall within the scope and spirit of the inventions.

What is claimed is:

1. A stereoscopic video display device comprising:
a depth information generator configured to generate a depth value from an input image;
a depth controller configured to adjust the depth value and generate an adjusted depth value;
an image generator configured to generate a right viewpoint image and a left viewpoint image from the input image and the adjusted depth value; and
an image display unit configured to display a stereoscopic image, based on the right and left viewpoint images, wherein
the depth controller creates a weighted histogram of the depth value by weighting a frequency of each depth value, and adjusts the depth value by using an accumulated weighted histogram obtained from the histogram.

2. The device of claim 1, wherein the depth controller increases a weighting for the frequency of the depth value if the depth value is small, and decreases the weighting for the frequency of the depth value if the depth value is large.

3. The device of claim 1, wherein the input image is an image which is imaged by a camera.

4. The device of claim 1, wherein the input image comprises a left image and a right image which are imaged by a plurality of cameras.

5. The device of claim 1, wherein the depth controller smoothes the weighted histogram by adjusting the depth value with use of a function which mixes a plurality of respectively different depth adjustment functions obtained from the accumulated weighted histogram.

6. A stereoscopic video display device comprising:
a depth information generator configured to generate a depth value from an input image;
a depth controller configured to adjust the depth value and generates an adjusted depth value; and
an image generator configured to generate a right viewpoint image and a left viewpoint image from the input image and the adjusted depth value, wherein
the depth controller creates a weighted histogram of the depth value by weighting a frequency of each depth value, and adjusts the depth value by using an accumulated weighted histogram obtained from the histogram.

7. A stereoscopic video display method comprising:
generating a depth value from an input image;
adjusting the depth value and generates an adjusted depth value;
generating a right viewpoint image and a left viewpoint image from the input image and the adjusted depth value; and
displaying a stereoscopic image, based on the right and left viewpoint images, wherein
the adjusting of the depth value comprises creating a weighted histogram of the depth value by weighting a frequency of each depth value, and adjusting the depth value by using an accumulated weighted histogram obtained from the histogram.

8. The method of claim 7, wherein the depth controller increases a weighting for the frequency of the depth value if the depth value is small, and decreases the weighting for the frequency of the depth value if the depth value is large.
